(19) United States
(12) Patent Application Publication
(10) Pub. No.: US 2002/0121757 A1
(43) Pub. Date: Sep. 5, 2002

(54) Transformable twist scooter

(76) Inventor: Richard Louh, Lung-Tan Hsiang (TW)

Correspondence Address: JACOBSON HOLMAN PLLC, 400 SEVENTH STREET N.W., SUITE 600, WASHINGTON, DC, 20004, US

(21) Appl. No.: 09/795,440

(22) Filed: Mar. 1, 2001

(51) Int. Cl. B62M 1/00; B62M 27/00

(52) U.S. Cl. 280/87.041; 280/14.28

(57) ABSTRACT

A transformable twist scooter has a handle assembly, a base, a front wheel assembly, a rear wheel assembly and a seat adjustably mounted on the base. The handle assembly has a pair of handle grips pivotally and oppositely connected to distal ends of a T-shaped tube that is adjustably connected to the base, such that the user is able to adjust the angle of the handle grips and the height of the seat to cope with differences in sizes of the user to provide the riding effect.

### BACKGROUND OF THE INVENTION

1. Field of the Invention

The present invention relates to a transformable twist scooter, and more particularly to a scooter that is able to move by swinging the handle or by paddling on the ground. Furthermore, the scooter has a seat adjustably mounted on the base of the scooter, such that the user is able to sit on the seat while playing the scooter.

2. Description of Related Art

A conventional scooter is shown in FIG. 10 and has a handle (1a), a base (2a), a front wheel (3a) and a rear wheel (4a).

The handle (1a) has a pair of grips (11a) and a T-shaped tube (12a). The T-shaped tube (12a) securely engages with the front wheel (3a) via a bracket (not numbered) so that the user is able to control the direction of the scooter by means of the handle (1a). When the scooter is in use, the user stands in one leg on the base (2a) that is securely mounted between the front wheel (3a) and the rear wheel (4a) and both hands firmly hold the grips (11a). Paddling on the ground with the other leg, the user is able to move by the assistance of the scooter.

It is to be noted that the scooter does provide a device having sport and entertainment features, it still suffers a number of drawbacks.

1. Because the diameter of both the front and rear wheels are small and there is no any cushion device provided on the scooter, such that when the scooter is moving on a bumpy surface, the user is not very comfortable.

2. The propelling power of this scooter mainly comes from the paddling of the user's leg on the ground, it is quite dull and not interesting to the user.

3. The area of the base is small so that when both of the user's feet are on the base, not only the user is not comfortable, but also the danger of using the scooter increases.

4. Because there is only one front wheel (3a) and one rear wheel (4a), the user needs to take extra precaution to keep balance to prevent falling.

5. The handle can not rotate to cope with the user's position change.

To overcome the shortcomings, the present invention intends to provide an improved scooter to mitigate or obviate the aforementioned problems.

### SUMMARY OF THE INVENTION

The primary objective of the invention is to provide a transformable twist scooter having a cushion device provided to the front wheel so that the counteraction force from the cushion device is able to provide a comfortable riding feeling to the user.

Another objective of the invention is to provide a transformable twist scooter that is able to move by swinging the handle. That is, the user is able to move the scooter by continuously pivoting the handle to the right and to the left.

Another objective of the invention is to provide a transformable twist scooter having a wide base such that the user is able to stand firmly and comfortably on the base with both feet.

Still another objective of the invention is to provide an improved transformable twist scooter having a pair of handle grips that are able to pivot to cope with the user's position change so as to provide a comfortable holding to the handle.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a transformable twist scooter constructed in accordance with the present invention;

FIG. 2 is an exploded perspective view of the transformable twist scooter of FIG. 1;

FIG. 3 is a perspective view of another preferred embodiment of the transformable twist scooter of the invention;

FIG. 4 is an exploded perspective view of the transformable twist scooter o FIG. 3;

FIG. 5 is an operational side view of the adjustment of the handle and the seat as shown in FIG. 3;

FIG. 6 is a front plan view of the adjustment of the handle of the transformable twist scooter of the present invention;

FIG. 7 is a plan view of the rear wheel assembly of the transformable twist scooter of the present invention;

FIG. 8 is an exploded plan view of the handle grip of the present invention;

FIG. 9 is an operational plan view of the pivoting of the handle grips of the present invention; and

FIG. 10 is a perspective view of a conventional scooter.

### DETAILED DESCRIPTION OF PREFERRED EMBODIMENT

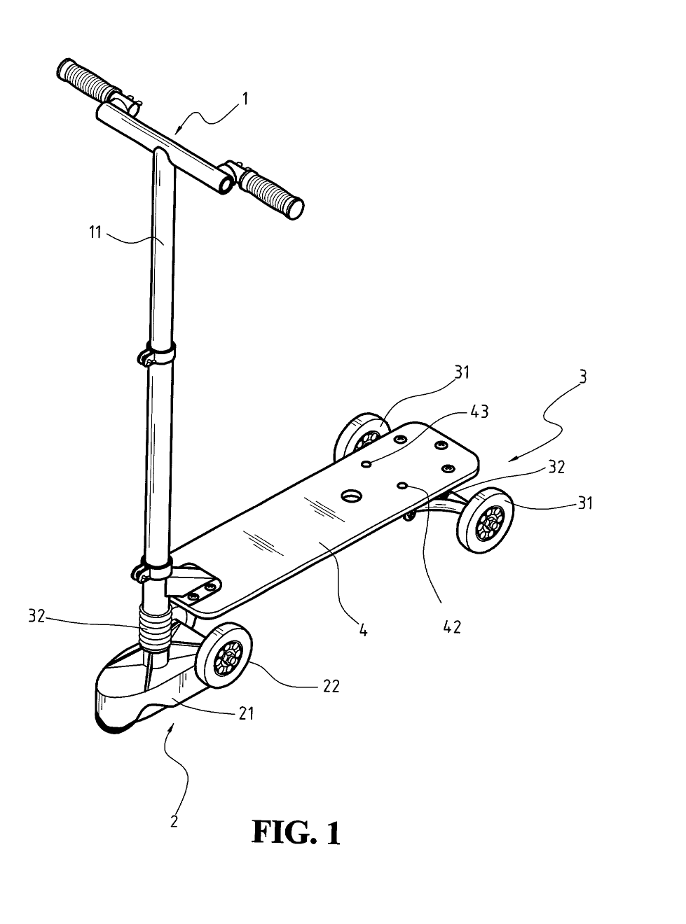

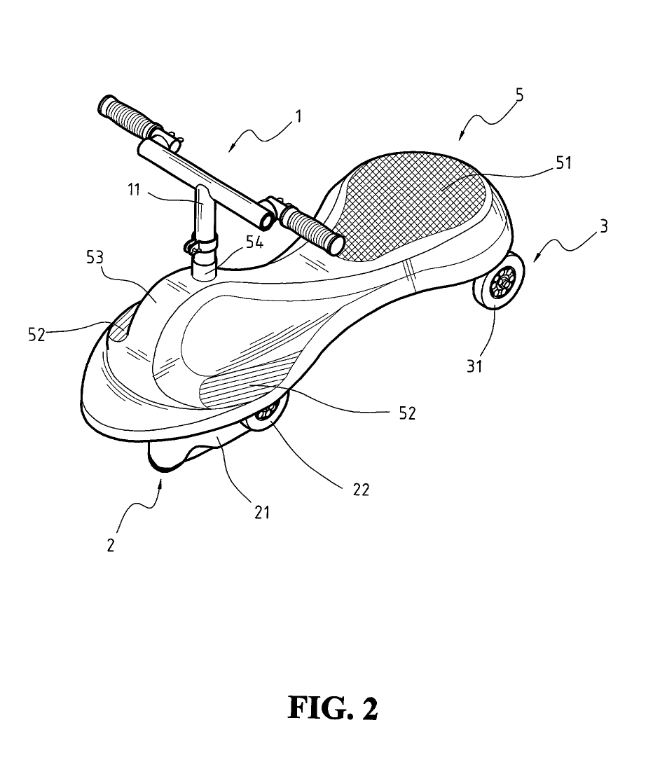

With reference to FIGS. 1 to 4, a transformable twist scooter in accordance with the present invention has a handle assembly (1), a front wheel assembly (2), a rear wheel assembly (3), a base (4) and a seat (5).

The handle assembly (1) has a T-shaped tube (11) and a support (12) with the T-shaped tube (11) adjustably inserted therein. Each distal end of the T-shaped tube (11) has a handle grip (15) pivotally connected thereto. A first retaining device (14), such as a C-clip, is provided on the support (12) so that after the T-shaped tube (11) is inserted into the support (12), the retaining device (14) is able to secure the engagement between the T-shaped tube (11) and the support (12).

The base (4) has a front tube (41) mounted on a first end thereof and having a through hole (411) defined to allow the extension of the support (12). Therefore, after the extension of the support (12) into the through hole (411) of the front tube (41), a second retaining device (412) is able to secure the engagement between the front tube (41) and the support (12).

A damping device (13) is received in the through hole (411) of the front tube (41) of the base (4) and has a damping spring (131), a washer (132) and a cover (133).

The front wheel assembly (2) has a body (21), a pair of front wheels (22) rotatably mounted on the body (21), a receiving hole (23) defined to correspond to the front tube (41) of the base (4) and a rubber pad (24) oppositely mounted to the front wheels (22). When the base (4), the damping device (13) and the front wheel assembly (2) are assembled, the damping spring (131) is received in the through hole (411) of the front tube (41) and a free end of which abuts against a free end of the support (12). The washer (132) is received in the receiving hole (23) to abut the other free end of the damping spring (131) and a bolt (111) is inserted into the receiving hole (23) and threadingly engages with the free end of the support (12). Thereafter, the cover (133) is provided outside the joint between the support (12) and the periphery of the receiving hole (23).

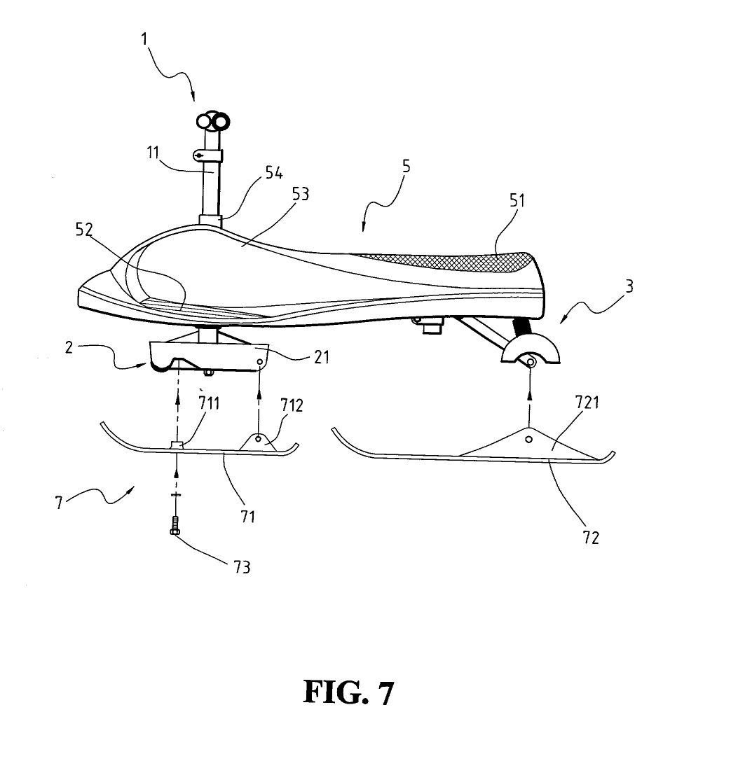

The rear wheel assembly (3), as shown in FIG. 7, has a pair of rear wheels (31) each oppositely mounted on the base (4) with respect to each other and a pair of suspension damper (32) each provided to one of the pair of rear wheels (22) and having a linkage (321) and a spring (322) mounted on the linkage (321), such that each of the suspension damper (32) is able to provide the necessary damping effect to the base (4) to provide a pleasant ride to the user. When the foregoing assembly is finished, the user, holding the handle (1), is able to stand firmly and comfortably on the base (4) and swing the handle (1) to advance with the assistance of the foregoing assembled structure.

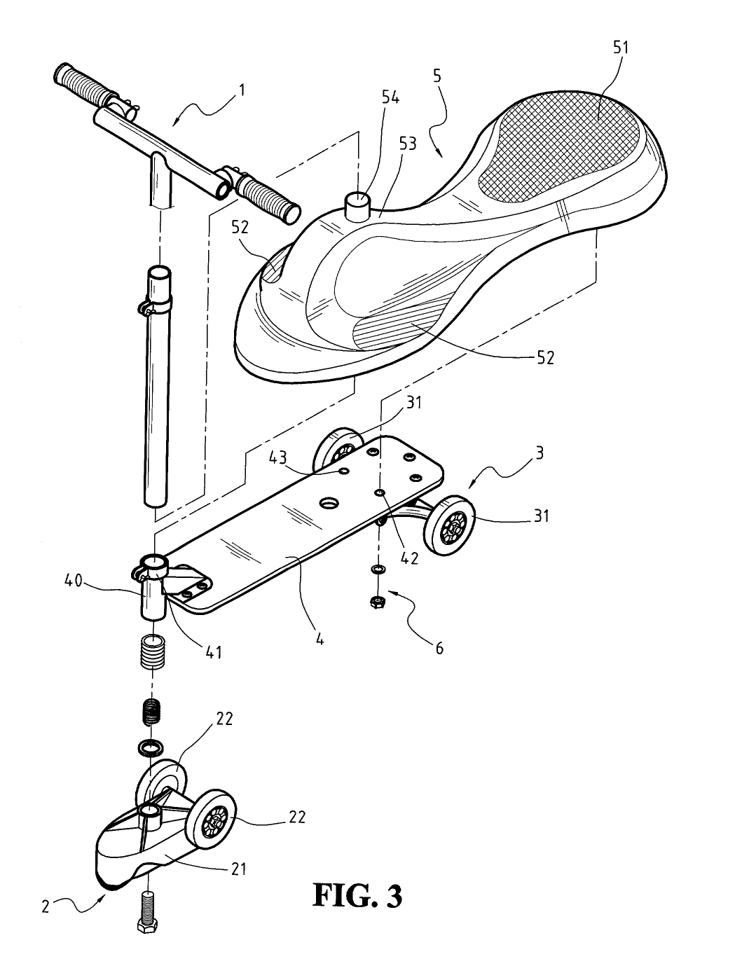

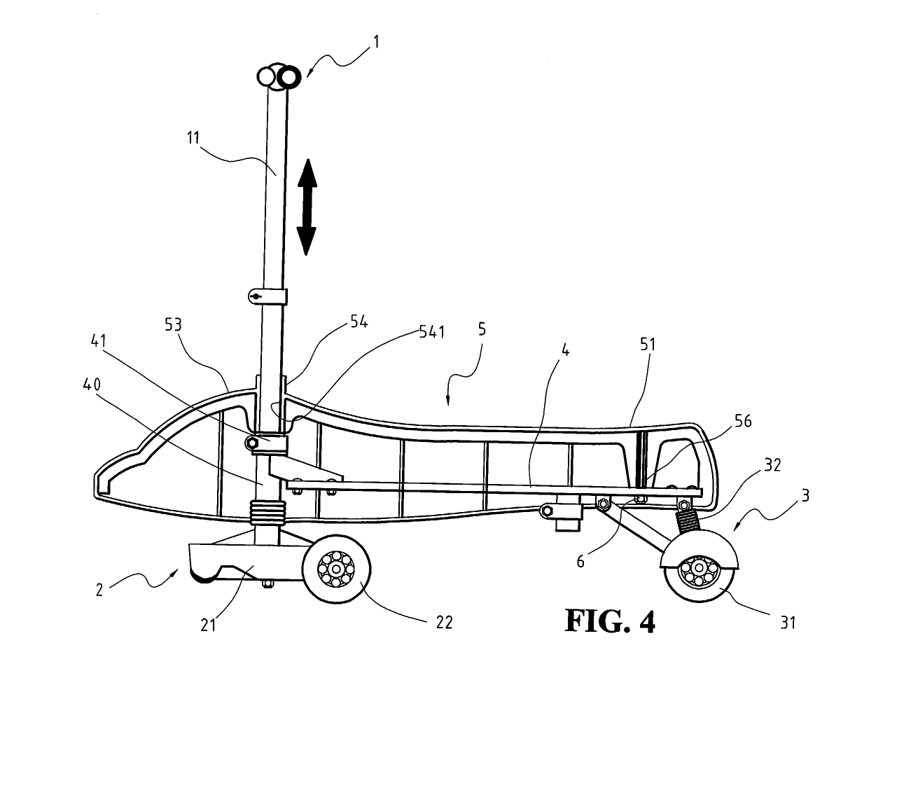

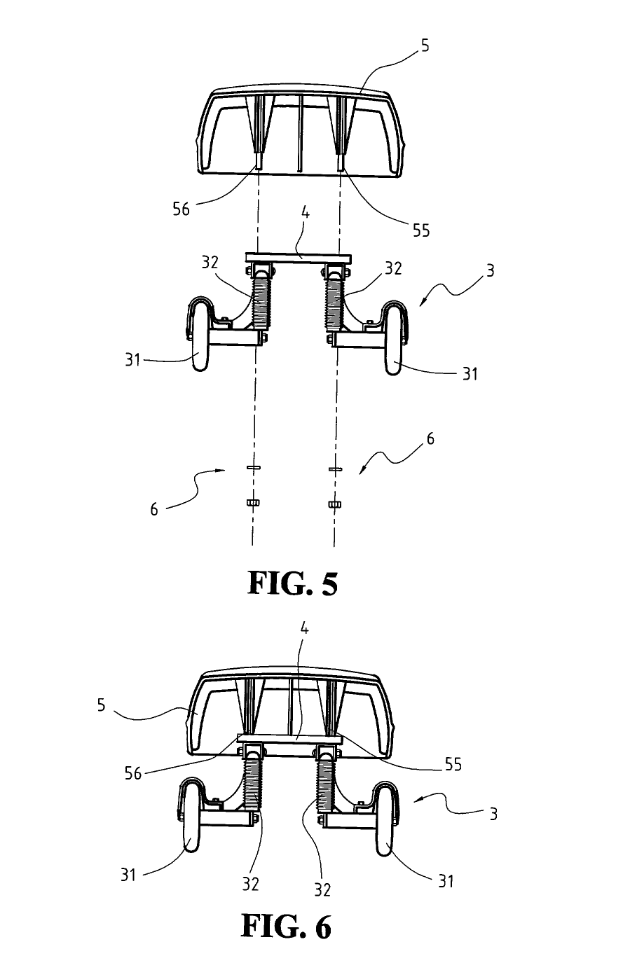

With reference to FIGS. 3 and 4, it is to be noted that the base (4) further has a hole (42) defined to correspond to a free end of a seat tube (53) that is provided with a third retaining device (531). A seat assembly (5) has a seat (51) and an extension (52) integrally extending out from a bottom of the seat (51). The extension (52) is inserted into the seat tube (53) and is able to be secured by the third retaining device (531). It is noted that not only the extension (52) is able to be adjusted by the third retaining device (531) with respect to the seat tube (53), but also the seat tube (53) is able to be adjusted by a fourth retaining device (532) provided underneath the base (4), such that after the seat tube (53) is inserted through the hole (42), the fourth retaining device (532) is able to secure the seat tube (53) to the base (4). Therefore, the user is able to sit on the seat (51) after the adjustment to the height of the seat tube (53) and/or the extension (52) to the seat tube (53) to cope with the size of the user and hold the handle (1) to move the scooter of the invention by swinging the handle (1), as shown in FIG. 5.

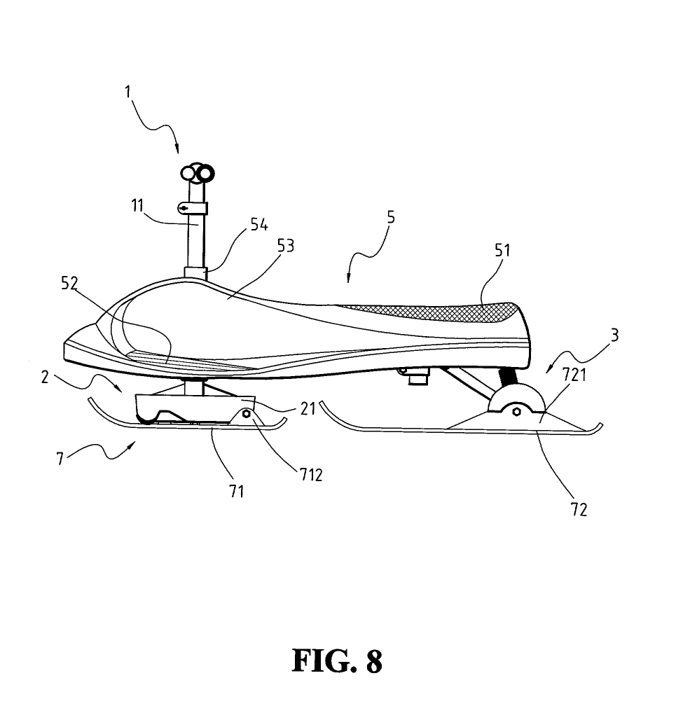

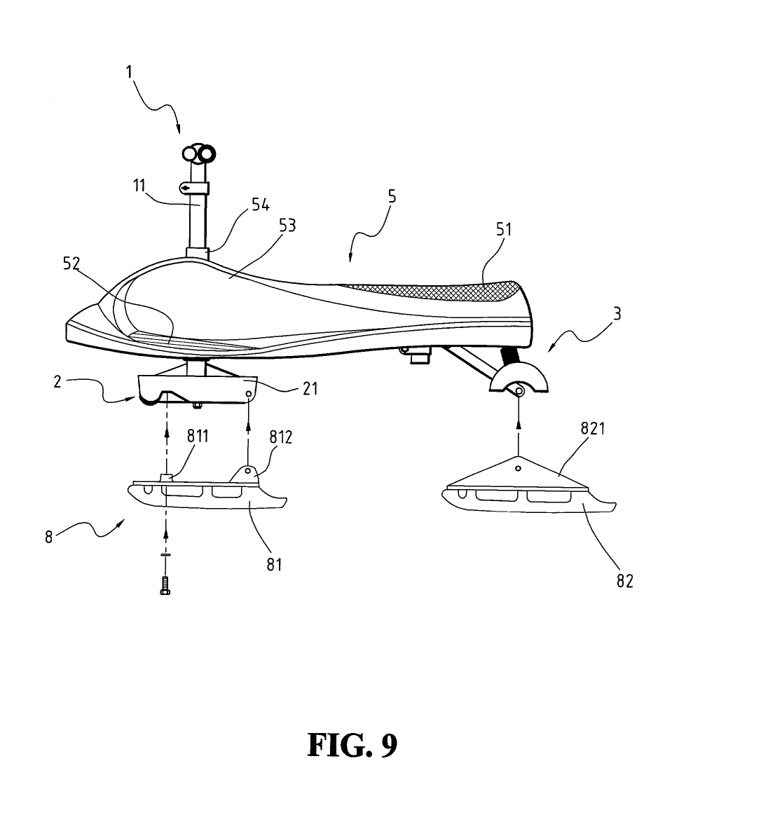

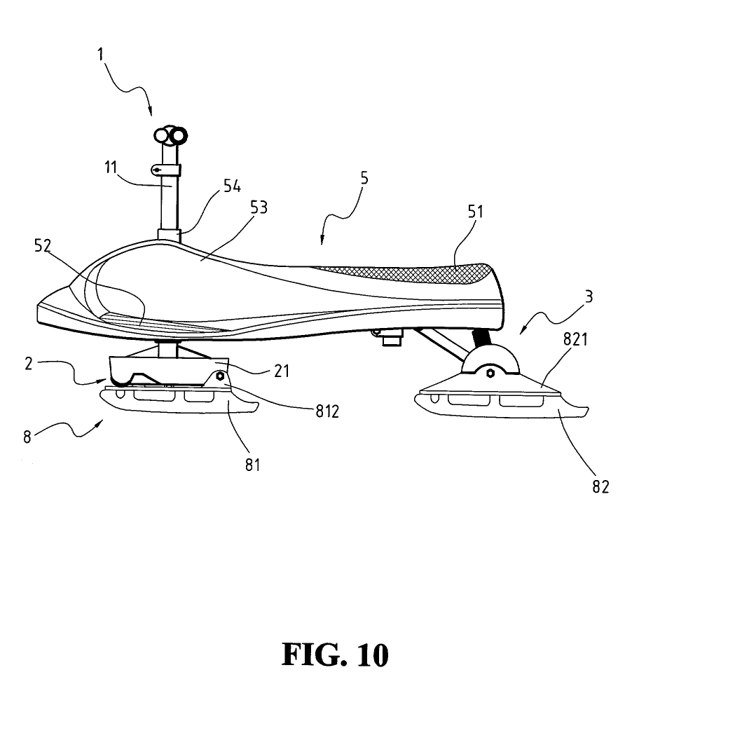

With reference to FIGS. 6, 8 and 9, the handle (1) comprises a pair of handle grips (151) oppositely and pivotally mounted on two distal ends of the T-shaped tube (11), a pair of disks (152) each having a first disk (1521) secured to a corresponding one of the handle grips (151) and a second disk (1522) secured to the distal end of the T-shaped tube (11), a pair of bolts (153) each inserted through corresponding one of the first and the second disks (1521,1522) and threadingly engaged with a nut (154) inside the T-shaped tube (11). The first disk (1521) is pivotal with respect to the second disk (1522), such that the handle grip (151) is able to pivot with respect to the T-shaped tube (11).

When the foregoing assembly is finished, the user is able to adjust the handle grips (151) to cope with the position change of the user so as to provide the most comfortable riding effect to the user.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A transformable twist scooter comprising:
a handle assembly having:
a T-shaped tube having a handle grip pivotally connected thereto; and
a support with the T-shaped tube adjustably inserted therein;
a first retaining device provided on the support so that after the T-shaped tube is inserted into the support, the first retaining device is able to secure the engagement between the T-shaped tube and the support;
a base having a front tube mounted on a first end thereof and having a through hole defined to allow the extension of the support, such that after the extension of the support into the through hole of the front tube, a second retaining device is able to secure the engagement between the front tube and the support;
a damping device received in the through hole of the front tube of the base and having a damping spring, such that the damping device is able to provide a damping effect to the base;
a front wheel assembly having a body, a pair of front wheels rotatably mounted on the body, a receiving hole defined to correspond to the front tube of the base and a rubber pad oppositely mounted to the front wheels, wherein when the base, the damping device and the front wheel assembly are assembled, the damping spring is received in the through hole of the front tube and a free end of which abuts against a free end of the support, and a washer of the damping device is received in the receiving hole to abut the other free end of the damping spring and a bolt is inserted into the receiving hole and threadingly engages with the free end of the support;
a rear wheel assembly oppositely mounted on the base to the front wheel assembly and having a pair of rear wheels each oppositely mounted on the base with respect to each other and a pair of suspension damper each provided to one of the pair of rear wheels and having a linkage and a spring mounted on the linkage, such that each of the suspension damper is able to provide the necessary damping effect to the base to provide a pleasant ride to the user.

2. The transformable twist scooter as claimed in claim 1, wherein the damping device further has a cover provided outside a joint between the support and the periphery of the receiving hole.

3. The transformable twist scooter as claimed in claim 1, wherein the base further has a hole defined to correspond to a free end of a seat tube that is provided with a third retaining device and a seat assembly adjustably received in the hole.

4. The transformable twist scooter as claimed in claim 2, wherein the base further has a hole defined to correspond to a free end of a seat tube that is provided with a third retaining device and a seat assembly adjustably received in the hole.

5. The transformable twist scooter as claimed in claim 3, the seat assembly has a seat and an extension integrally extending out from a bottom of the seat and inserted into the seat tube, the extension being able to be secured by the third retaining device.

6. The transformable twist scooter as claimed in claim 4, the seat assembly has a seat and an extension integrally extending out from a bottom of the seat and inserted into the seat tube, the extension being able to be secured by the third retaining device.

7. The transformable twist scooter as claimed in claim 4, wherein the seat tube is adjusted by a fourth retaining device provided underneath the base, such that after the seat tube is inserted through the hole, the fourth retaining device is able to secure the seat tube to the base.

8. The transformable twist scooter as claimed in claim 2, wherein the handle assembly further comprises a pair of disks each having a first disk secured to a corresponding one of the handle grips and a second disk secured to the distal end of the T-shaped tube, a pair of bolts each inserted through a corresponding one of the first and the second disks and threadingly engaged with a nut inside the T-shaped tube, wherein the first disk is pivotal with respect to the second disk, such that the handle grip is able to pivot with respect to the T-shaped tube.

9. The transformable twist scooter as claimed in claim 3, wherein the handle assembly further comprises a pair of disks each having a first disk secured to a corresponding one of the handle grips and a second disk secured to the distal end of the T-shaped tube, a pair of bolts each inserted through a corresponding one of the first and the second disks and threadingly engaged with a nut inside the T-shaped tube, wherein the first disk is pivotal with respect to the second disk, such that the handle grip is able to pivot with respect to the T-shaped tube.

10. The transformable twist scooter as claimed in claim 4, wherein the handle assembly further comprises a pair of disks each having a first disk secured to a corresponding one of the handle grips and a second disk secured to the distal end of the T-shaped tube, a pair of bolts each inserted through a corresponding one of the first and the second disks and threadingly engaged with a nut inside the T-shaped tube, wherein the first disk is pivotal with respect to the second disk, such that the handle grip is able to pivot with respect to the T-shaped tube.

11. The transformable twist scooter as claimed in claim 5, wherein the handle assembly further comprises a pair of disks each having a first disk secured to a corresponding one of the handle grips and a second disk secured to the distal end of the T-shaped tube, a pair of bolts each inserted through a corresponding one of the first and the second disks and threadingly engaged with a nut inside the T-shaped tube, wherein the first disk is pivotal with respect to the second disk, such that the handle grip is able to pivot with respect to the T-shaped tube.

12. The transformable twist scooter as claimed in claim 6, wherein the handle assembly further comprises a pair of disks each having a first disk secured to a corresponding one of the handle grips and a second disk secured to the distal end of the T-shaped tube, a pair of bolts each inserted through a corresponding one of the first and the second disks and threadingly engaged with a nut inside the T-shaped tube, wherein the first disk is pivotal with respect to the second disk, such that the handle grip is able to pivot with respect to the T-shaped tube.

13. The transformable twist scooter as claimed in claim 7, wherein the handle assembly further comprises a pair of disks each having a first disk secured to a corresponding one of the handle grips and a second disk secured to the distal end of the T-shaped tube, a pair of bolts each inserted through a corresponding one of the first and the second disks and threadingly engaged with a nut inside the T-shaped tube, wherein the first disk is pivotal with respect to the second disk, such that the handle grip is able to pivot with respect to the T-shaped tube.
